(19) United States
(12) Patent Application Publication
(10) Pub. No.: US 2024/0099259 A1
(43) Pub. Date: Mar. 28, 2024

(54) Cat Litter Collection Systems

(71) Applicant: Kim Oldencamp, St. Joseph, MO (US)

(72) Inventor: Kim Oldencamp, St. Joseph, MO (US)

(21) Appl. No.: 18/504,305

(22) Filed: Nov. 8, 2023

Related U.S. Application Data
(63) Continuation of application No. 17/401,238, filed on Aug. 12, 2021, now abandoned.
(60) Provisional application No. 63/064,873, filed on Aug. 12, 2020.

(51) Int. Cl. A01K 1/01

(52) U.S. Cl. CPC A01K 1/0107

(57) ABSTRACT

The present invention provides improved systems for maintaining a litter box and removing used litter. The systems provide a raised surface for a litter box that is accessible to a cat; easier to access for cleaning; and provides storage for litter and associated supplies. When not being cleaned, the litter box is hidden from view. Advantageously, the system has a furniture-like appearance so it can be placed in a variety of interior spaces within a home without detracting from the décor.

### BACKGROUND OF THE INVENTION

### A. Field of the Invention

The present invention relates to improved systems for an enclosed, elevated litter box having the appearance of furniture.

### B. Description of the Related Art

Many people keep their cats indoors. Consequently, litter boxes are a necessity in their homes. Few homes are built with a separate, dedicated area that is suitable for a litter box. Consequently, litter boxes must be kept in an area where people or other animals are present. Litter boxes, especially when in use, are unsightly and can be a source of unpleasant odors.

Due to its small particle size and because cats often cover their excrement, litter often becomes scattered outside of the litter box. It is not unusual for cats to track litter outside of the litter box for several feet. This scattered litter is unattractive and requires additional cleaning.

While many litter box enclosures have been designed to limit the scatter of litter, these enclosures also limit the space available for a cat to move about while using the litter box. Many cats balk at entering and using such confined spaces, especially if they are part of a multi-pet household and are not the dominant pet. Additionally, conventional litter box enclosures are not designed to limit access to the litter by other animals such as dogs, which are often attracted to cat excrement. If dogs have access to used litter, they may develop coprophagia, which can lead to blockages of the digestive tract and the transmission of parasites.

Because cat litter is commonly clay-based and is designed to absorb moisture, it is relatively heavy. Cleaning a litter box can be a challenge for people with limited strength, mobility, or balance difficulties.

### SUMMARY OF THE INVENTION

The present invention provides systems that provide both easy access for a cat to a litter box, as well as, improved accessibility to clean and maintain the litter box and the area surrounding it. Advantageously, systems of the invention allow all necessary supplies and tools for cleaning and maintaining a litter box to be conveniently stored together near the litter box and within an enclosed area. A particular advantage of the invention is that a user does not need to stoop down to the ground to maintain a litter box. The reduced need to bend over is particularly desirable for users with poor mobility or balance.

Further, the present invention effectively hides a litter box from view without limiting a cat's access to it by disguising the housing as a piece of furniture. By disguising the housing as a piece of furniture, a litter box can be placed nearly anywhere within a home without detracting from a home's décor or diminishing the utility of an area. All supplies for maintaining and cleaning a litter box can be stored within a system of the invention. Advantageously, the areas for such supplies can have a variety of configurations within systems of the invention such that the supplies can be positioned above, below, laterally, or a combination thereof relative to a litter box.

The invention provides a system for animal waste containment comprising a back wall; two side walls (i.e. a first side wall and a second side wall) that are spaced apart from each other and attached to the back wall, wherein at least one side wall includes an opening of sufficient size for a cat to pass through; a base that is attached to the side walls and back wall, wherein the base has a flat interior surface adjacent to the side walls and back wall; a first shelf that is connected to the two side walls or to the back wall and at least one side wall, wherein the first shelf is raised above and relatively parallel to the interior surface of the base, includes an opening of sufficient size for a cat to pass through, and can accommodate a litter box; a first oblique structure near the back wall that has a first end adjacent to the opening in the first shelf and a second end near the opening in the side wall; a top; and a front that is attached to the side walls and includes at least one door, wherein the exterior of the system has a furniture-like appearance. Alternatively, the front can be attached to either the top or base.

The top can be attached to the back wall or to the back wall and the side walls. Alternatively, the top is not attached to either the back wall or side walls and acts as a removable lid to the system.

Preferably the first oblique structure is a ramp, a stairs, or a combination thereof and is removable. Optionally, the first oblique structure can be attached to a side wall, back wall, base, a shelf, or a combination thereof, as long as, the first oblique structure can be detached and removed as desired or needed.

In certain alternative embodiments, systems of the invention do not include an oblique structure such as a ramp or stairs. In these embodiments, the first shelf is placed so that a cat can easily move through the shelf opening to the upper surface of the first shelf or to the opening in the side wall to exit the system.

In some embodiments, the height of the first shelf is adjustable relative to the base. In these embodiments, the first oblique structure is adjustable such that its first end remains adjacent to the opening in the first shelf and its second end remains adjacent to the opening in the side wall. In other embodiments the height of the first shelf is fixed relative to the base.

Advantageously, certain embodiments of the invention include a scratching post or climbing pole that is attached to either the top, a first shelf, a side wall, the back wall, or a combination thereof. The scratching post or climbing post can be constructed from a wide variety of materials and covered with a material that encourages a cat to sharpen its claws and thereby clean extraneous litter from its paws. Suitable materials are well known in the arts.

Preferred systems of the invention have an open interior situated between the base and the first shelf that provides a storage area. In these embodiments, the front preferably includes a second door that provides greater access to the interior located between the base and the first shelf. For example, in these embodiments a first door can provide access to the first shelf and the interior area above the first shelf, and a second door can provide access to the storage area below the first shelf. Alternatively, doors can be placed side-by-side. Those of skill in the art will appreciate that more doors may be present. For example, a system may include several or more doors to match a particular style of décor.

Storage areas located in the interior of the system can include one or more drawers, or alternatively, one or more removable storage containers such as a caddies or bins.

In certain embodiments of the invention, the first shelf includes a removable flooring. Preferably, this removable flooring comprises a plastic or rubber-like material. Those of skill in the art will recognize that a variety of removable flooring materials may be used within a system of the invention. It is most desirable that such flooring materials are easily cleaned and moisture repellant.

Preferably, the oblique structure includes a non-skid covering, and this non-skid covering is removable so that it may be cleaned or replaced more easily. In some embodiments, the oblique structure includes a covering comprising carpet, rope, cloth, or another suitable material. An oblique structure can include both a non-skid covering and another material. Preferably in such embodiments, the surfaces of the oblique structure that are most likely to require cleaning (e.g. the upper surfaces of steps or ramps) are covered by removable or easy to clean materials. Alternatively, an oblique structure can have a rough or irregular surface. In such instances, the rough or irregular surface is easy to clean such as with a vacuum, brush, or dust cloth.

In some instances, it may be desirable to elevate the opening in the side wall through which a cat may enter or exit the system. In these embodiments, an exterior oblique structure may present to provide easier access to the opening in the side wall. It may be desirable to enclose the exterior oblique structure. The enclosure may be made from a wide variety of suitable materials that are known in the art.

In some embodiments, systems of the invention further include a second shelf that is raised above and relatively parallel to the first shelf. This second shelf includes an opening of sufficient size for a cat to pass through and a flat surface of sufficient size to accommodate a litter box. A second shelf can include a removable flooring made of a rubber-like or plastic material or any other suitable material. Those of skill in the art will appreciate that more than one second shelf may be present. Several factors can determine the number of shelves that are present in a specific embodiment of the invention. For example, the size and dimensions of the space into which the system will be placed, the type of décor that the exterior of the system is intended to match, and the number of cats that will be using the system are some of the factors that will determine the number of shelves that are present in a specific system.

Preferably, systems of the invention that have a second shelf or shelves also include a second oblique structure that has a first end in contact with the first shelf and a second end adjacent to the opening in the second shelf. This second oblique structure is a ramp, stairs, or combination thereof and preferably is removable. In some embodiments, multiple second shelves may be present. In these embodiments, multiple second oblique structures can also be present. Alternatively, a second oblique structure(s) may not be present, as long as, a cat can easily move from the opening in a second shelf to either another second shelf or back to a first shelf.

In some embodiments, systems of the invention include a storage shelf that is raised above and relatively parallel to the first shelf, wherein this storage shelf does not include an oblique structure. The storage shelf may be adjustable or fixed in placed.

Certain embodiments of the invention include a lateral storage area that is adjacent to a side wall. Lateral storage areas can include one or more storage shelves or drawers or combinations thereof. These lateral storage areas can be accessed by one or more doors that are attached to the front of the system. Those of skill in the art will appreciate that the position of any storage area within a system depends, at least in part, upon the overall size and dimensions of a system, user preferences, and the sizes and types of supplies to be stored.

In certain embodiments, a first shelf further comprises a hinged section that is located adjacent to the opening in the first shelf such that the hinge is parallel to and near one side wall. This hinged section is slightly higher than the section of the first shelf that supports a litter box so that a user can easily raise the hinged section.

Systems of the invention can include casters coupled to the exterior of the base, a plurality of legs attached to the exterior of the base, or a combination thereof.

Systems of the invention can further comprise a frame that is attached to the side walls, back wall, top, and base. Skilled artisans will familiar with the use of frames and frameworks in furniture making.

In some embodiments, the top is hinged and can be raised from its resting horizontal position to access the interior of the system. In such embodiments, the top may fold back on itself or a means of holding the top in the raised position may be included. Those of skill in the arts will be familiar with the wide variety of ways to hold a furniture lid open. It is expected that many of these means are suitable for use in the invention.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description. Further, while specific advantages of the invention are detailed herein, various embodiments may include some, none, or all of these enumerated advantages.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description presented herein. Unless specifically noted, articles depicted in the drawings are not necessarily drawn to scale.

FIG. 1 illustrates a front view of an exemplary embodiment of the system with the doors open.

FIG. 2 illustrates the same exemplary embodiment with the doors removed.

FIG. 3 shows an embodiment with two shelves and two oblique structures.

FIG. 4 shows a shelf that includes a hinged member or section.

### DETAILED DESCRIPTION

The invention provides improved systems for cleaning and maintaining a litter box. The systems are enclosed such that litter that is scattered outside of the litter box is kept within a confined area. Advantageously, these systems have furniture-like appearances that allow them to be placed in a wide variety of areas of a home without detracting from the décor or becoming unsightly. Because systems of the invention are substantially enclosed, odors are minimized.

The present invention improves upon prior enclosures for litter boxes by taking advantage of a cat's natural tendencies to explore and climb. The invention provides systems that have enclosures with large interior areas and preferably at least one oblique structure, such as a ramp, stairs, or combination thereof that is suitable for a cat to climb. By elevating the litter box above the entryway, these systems greatly reduce, or even eliminate, the access of other animals such as dogs to the litter box. In addition, elevating the litter box so that it is separated from the entryway also reduces the scatter of litter into areas outside of the system.

Elevating the litter box also reduces or eliminates the need to stoop or bend over to clean it. By reducing or eliminating the need to bend over the litter box, a person's exposure to litter dust and associated cat excrement is reduced. Further, persons having limited mobility or strength are able to use a more upright posture while cleaning, which is generally less physically taxing.

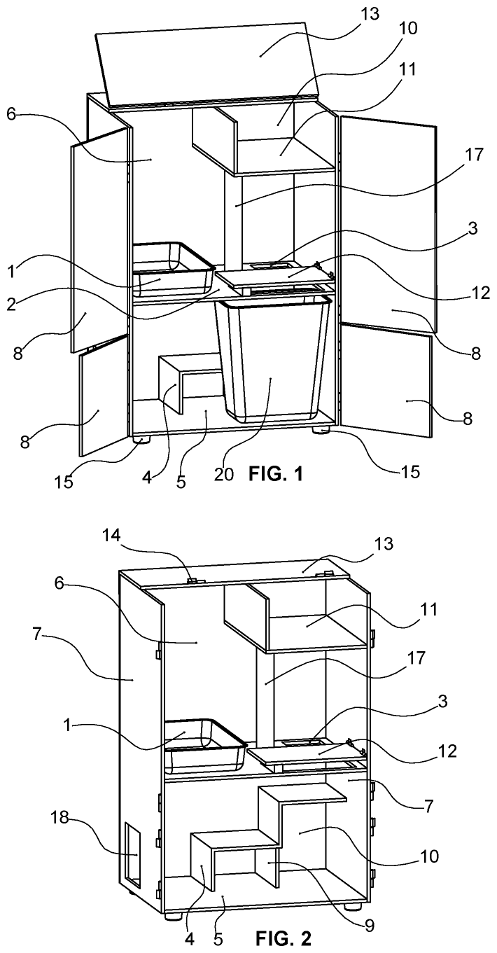

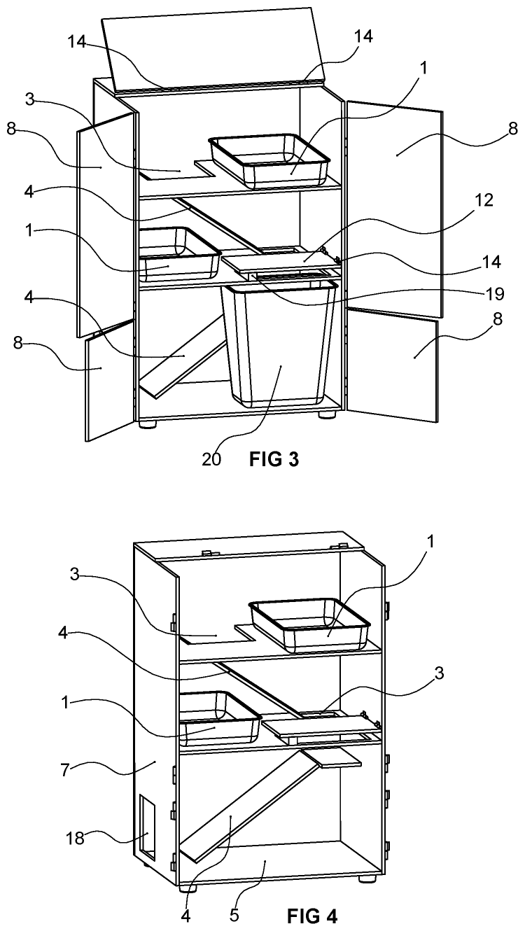

FIGS. 1 and 2 illustrate an exemplary embodiment of the invention. A litter box 1 rests upon one side of an elevated shelf 2. Adjacent to the litter box is an opening 3 (a hole) in the shelf 2. One end (the top) of a stairs 4, which is one example of a suitable oblique structure 4, is in contact with an edge of the opening 3 in the shelf 2 (FIGS. 3 and 4).

Those of skill in the art will appreciate that an oblique structure 4 does not necessarily need to be in direct contact with the edge of the opening 3 in the shelf 2. The end of the oblique structure need only be near enough to the opening so that a cat may easily move from the oblique structure to the shelf and back again. See FIGS. 2-4.

Advantageously, while the oblique structure 4 can be connected to the shelf 2, base 5, back wall 6, a side wall 7, or any combination thereof the oblique structure 4 does not need to be permanently fixed in place. Rather, it is preferable that the oblique structure 4 can be removed for cleaning or adjusted to vary its angle and height to improve a cat's use of the oblique structure. An oblique structure's position can be maintained through a variety of means. For example, the surface of the bottom end (sole) of the oblique structure 4 that rests on the interior surface of the base 5 may include a material (e.g. rubbers, plastics, or the like) that when combined with the weight of the oblique structure generates sufficient friction against the interior surface of the base to hold the oblique structure 4 in place. In addition, the interior surface of the base 5 may include such a material.

Those of skill in the art will recognize that in some instances a user may prefer that a first shelf 2 is not adjustable but is constructed in a fixed position. In such instances, the oblique structure 4 also can be fixed in position. Preferably, at least the coverings of such fixed first shelves and oblique structures are removable.

Oblique structures can be kept in place during use with a variety of fasteners that can be easily disconnected. For example, VELCRO®, pegs, magnets, hook and eyes, and French cleats are well known means of holding a structure in place. Many other means of temporarily holding a structure in place are known and may be used, alone or in combination, in the invention. It is only necessary that the fastening means is capable of being disconnected and reconnected so that the oblique structure either can be removed or its position adjusted.

Alternatively, an oblique structure 4 may include a permanent piece(s) that holds the oblique structure in position. For example, a brace 9 can be attached to the underside of an oblique structure 4, and the brace 9 can be positioned to hold the oblique structure 4 in position. See FIG. 2. Alternatively, such braces 9 can be attached to a frame 16, a side wall 7, the back 6, or a combination thereof.

Preferably, obliques structures are ramps, stairs, or a combination thereof. See FIGS. 2-4. These structures may include one or more turns or curves along their length as long as the structures are removable or their positions adjustable. Alternatively, an oblique structure can comprise two or more ramps, stairs, or combinations thereof. Further, the slope of an oblique structure can vary over its length. It is only necessary that the structure provides a means for a cat to move from one level to another within a system of the invention. Preferred oblique structures are located inside systems of the invention and one end (the bottom end) of the oblique structure is adjacent to the opening 18 in a side wall 7 so that a cat can enter or exit a system of the invention.

As shown in FIGS. 1 and 2, a shelf 2 can include a scratching post or climbing post 17. It is expected that when a cat uses such a device any litter that has adhered to the cat's paws may be dislodged and remain inside of the system.

In addition, storage shelf 11 that is above the first shelf 2 may be present. As illustrated in FIGS. 1 and 2, this storage shelf 11 provides a storage area 10 that may be used for supplies or tools for cleaning and maintaining the litter box.

Systems of the invention can include a second shelf 2 that provides a place for a second litter box 1. See FIGS. 3-4. These second shelves are similar to the first shelves. Specifically, these second shelves 2 have a space suitable for placing a second litter box 1 and an opening 3. A second oblique structure 4 has a bottom end in contact with the first shelf 2 and an upper end that is adjacent to the opening 3 in the second shelf 2. These second oblique structures are similar to first oblique structures.

In systems that have both a first and a second shelf, the height of one or both shelves can be adjusted. In alternative embodiments, both shelves may be fixed. A wide variety of means of attaching shelving to vertical surfaces such that the shelving is adjustable are known. Exemplary means of attachment include shouldered dovetail housing, shelving brackets, pins, braces, French cleats, and the like.

Both first and second shelves can be constructed from a wide variety of materials. Preferred materials are suitable for use in humid environments, do not readily absorb odors, and are not readily suitable for the growth of bacteria or other disease-causing agents. Preferred materials are easily cleaned and disinfected. Shelves may include a removable covering that is constructed of a plastic, plastic-like material, or other material that is non-absorbent and easily cleaned.

Preferred systems include a storage area 10 below the first shelf 2. See FIG. 2. Alternatively, storage areas can be located laterally in the system and adjacent to one side wall. The flexibility of the storage locations allows for systems of the invention to have a variety of furniture-like appearances that are suitable for a variety of décors and spaces. In some embodiments, lateral storage areas are accessed by a separate door such that the litter box is not directly accessed by the separate door.

To further enhance the ease of cleaning, certain embodiments of the invention include a hinged member 12 (or hinged section) in a shelf 2. The hinged member 12 allows a user to access the area directly below the shelf 2. It is envisioned that a trash receptacle 20 is placed in the accessible area so that a user can place or sweep used litter or other debris into the receptacle without having to remove the receptacle from the system.

A shelf 2 that includes a hinged member 12 is shown in FIG. 4. The hinged member 12 is located adjacent to both the opening 3 in the shelf 2 and the section of the shelf 2 upon which a litter box 1 can be placed. So that the hinged member 12 can be easily raised, it is not flush with the adjacent portion of the shelf 2. In FIG. 4, the hinged member 12 rests upon a dividing member 19, is slightly raised relative to the shelf 2, and is in an essentially horizontal position. Alternatively, the edge of the hinged member 12 farthest from its hinge can rest directly on the surface of the shelf 2, and the hinged member 12 will be at a slight incline relative to the shelf 2. The hinged member 12 can be raised to its fully upright (open, raised) position so that access to the area below the shelf 2 is accessible.

In some preferred embodiments, casters 15, legs 15, or a combination thereof are attached underneath the base 5. A variety of casters and legs are known in the arts and may be used in systems of the invention. The choice is dependent upon the type of furniture appearance that is being mimicked, as well as, whether the system is to be movable. In other embodiments, no casters or legs are included, and the base 5 rests on the floor.

Frames or frameworks 16 may be present. Frames are well known supporting structures in furniture making A variety of frame configurations are suitable for use in the invention. Cross members may or may not be present. The choice of frame design and construction materials is at least in part dependent upon the desired outer furniture appearance of a specific system of the invention, as well as, the materials used to construct the pair of side walls, back wall, and top.

In preferred systems, the top 13 includes one or more top hinges 14 so that the top 13 is capable of being raised so that the interior of the system can be accessed through the top 13. See FIG. 1. Preferably, hinged tops either fold back upon themselves or include a brace or other device that allows the top to remain in the open position until intentionally lowered.

Unless defined otherwise, all technical and scientific terms used herein have the same meaning as is commonly understood by one of skill in the art to which this invention belongs at the time of filing. Terminology used herein is for the purpose of describing particular embodiments of the invention and is not intended to be limiting. The meaning and scope of terms should be clear; however, in the event of any latent ambiguity, definitions provided herein take precedent over any dictionary or extrinsic definition. Further, unless otherwise required by context, singular terms shall include pluralities and plural terms shall include the singular unless the content clearly dictates otherwise. Herein, the use of “or” means “and/or” unless stated otherwise. Furthermore, the use of the term “including”, as well as other forms such as “includes” and “included” is not limiting. As used herein, “each” refers to each member of a set or each member of a subset of a set. Any patents and publications referred to herein are incorporated by reference.

It should be appreciated by those of skill in the art that the systems disclosed herein represent those discovered by the inventor to function well in practice, and thus can be considered to constitute preferred modes of practice. However, those of skill in the art should, in light of the present disclosure, appreciate that numerous changes can be made in the specific embodiments which are disclosed and still obtain a like or similar result without departing from the spirit and scope of the invention. Thus, the present invention should not be limited to the exemplary embodiments illustrated herein.

What is claimed is:

1. A system for animal waste containment comprising
a) a top;
b) a pair of side walls that are spaced apart from each other, wherein at least one side wall includes an opening of sufficient size for a cat to pass through;
c) a back wall that is attached to the top and the side walls;
d) a base that is attached to the side walls and back wall and that has a flat interior surface adjacent to the side walls and back wall;
e) a first shelf that is connected to the back wall, one or both side walls, or a combination thereof and that is raised above and relatively parallel to the flat interior surface of the base, wherein the first shelf includes an opening of sufficient size for a cat to pass through and a flat surface of sufficient size to accommodate a litter box;
f) a first oblique structure near the back wall that has a first end adjacent to the opening in the first shelf and a second end near the opening in the side wall; and
g) a front that is attached to the side walls and that includes at least one door,
wherein the exterior of the system has a furniture-like appearance.

2. The system of claim 1, wherein the first oblique structure is a ramp, stairs, or combination thereof and is removable.

3. The system of claim 1, wherein the height of the first shelf is adjustable relative to the base.

4. The system of claim 3, wherein the first oblique structure is adjustable such that its first end remains adjacent to the opening in the first shelf and its second end remains adjacent to the opening in the side wall.

5. The system of claim 1, wherein the front includes a second door that provides access to the interior of the system between the base and the first shelf.

6. The system of claim 1 further comprising a scratching post or climbing pole that is attached to the top, the first shelf, a side wall, the back wall, or a combination thereof.

7. The system of claim 1, wherein the interior situated between the base and the first shelf includes a storage area.

8. The system of claim 7, wherein the storage area includes one or more drawers.

9. The system of claim 1, wherein the first shelf includes a removable flooring that comprises a plastic material or a moisture repellent material.

10. The system of claim 1, wherein the oblique structure includes a non-skid covering.

11. The system of claim 1 further comprising a second shelf that is raised above and relatively parallel to the first shelf, wherein the second shelf includes an opening of sufficient size for a cat to pass through and a flat surface of sufficient size to accommodate a litter box.

12. The system of claim 11 further comprising a second oblique structure that has a first end in contact with the first shelf and a second end adjacent to the opening in the second shelf.

13. The system of claim 12, wherein the second oblique structure is a ramp, stairs, or combination thereof and is removable.

14. The system of claim 1 further comprising a storage shelf that is raised above and relatively parallel to the first shelf.

15. The system of claim 1, wherein the first shelf includes a hinged section adjacent to the opening in the first shelf, wherein the hinge is attached to a side wall, back wall, a frame, or the first shelf.

16. The system of claim 1 further comprising a plurality of casters, legs, or a combination thereof attached to the exterior of the base.

17. The system of claim 1 further comprising a frame attached to the side walls, back wall, top, base, or a combination thereof.

18. The system of claim 1, wherein the top is hinged.
